(19) United States
(12) Patent Application Publication
(10) Pub. No.: US 2023/0132880 A1
(43) Pub. Date: May 4, 2023

(54) LASER TURNING SYSTEM, LASER TURNING METHOD USING SUCH A SYSTEM, AND PART OBTAINED BY SUCH A METHOD

(71) Applicant: ROLEX SA, Geneva (CH)

(72) Inventors: Cédric Chautemps, Le Grand-Bornand (FR); Alexandre Oliveira, Amancy (FR); Matthias Portellano, Talence (FR)

(73) Assignee: ROLEX SA, Geneva (CH)

(21) Appl. No.: 17/917,951

(22) PCT Filed: Apr. 9, 2021
(86) PCT No.: PCT/EP2021/059358

§ 371 Date: Oct. 10, 2022

(30) Foreign Application Priority Data
Apr. 10, 2020 (EP) 20169209.2

(51) Int. Cl. G04D 3/00; B23K 26/082; B23K 26/08; B23K 26/362; B23K 26/0622; B23K 26/03

(52) U.S. Cl. CPC G04D 3/0069; B23K 26/082; B23K 26/0823; B23K 26/362; B23K 26/0624; B23K 26/032

(57) ABSTRACT

The present application describes a laser turning system (1) for producing a timepiece component, the system including a rotary spindle (3) for moving a bar of material (50) and a galvanometric scanner (12) capable of emitting a femtosecond laser beam scanning a generating profile of the component to be machined in the bar of material (50).

The invention relates to a laser turning system. The invention relates also to a laser turning method. The invention relates finally to a component obtained by the use of such a system or by the implementation of such a method.

### BACKGROUND ART

In order to produce components comprising one or more forms of revolution, it is known practice to implement a material removal-based machining method of turning type. Conventionally, the removal of material is done using a cutting tool acting on a bar of material that is made to rotate and from which the component is wanted to be obtained.

The production of timepiece components of revolution of small dimensions with high precision, such as timepiece staffs, is generally performed by turning, in particular by bar-turning of the components in series in a metal bar. This allows for industrial production rates, but presents a few drawbacks linked to the nature of the materials to be machined.

While it is relatively easy to bar-turn materials specifically suited to this technique, such as the bar-turning steels containing a chip-breaker element such as sulfur, the bar turning of parts made of ceramic, but also of hard metals, causes great wear of the tools, which renders this technique unproductive compared to its application to more suitable materials. Furthermore, the bar turning of hard materials generally induces vibration of the bar and does not make it possible to achieve the required surface roughnesses.

The laser turning performed with continuous laser sources (for example CO2 laser) has been widely developed in the industry, but it makes it possible to achieve only precisions of the order of a few tenths of millimeters, which can prove inadequate for certain applications and its thermal impact on the components obtained can generate local hardenings that are damaging to the microstructure of the material, or even worse, thermal deformations which affect the dimensions of the part, notably in the case of components of small volume. Because of this, it has not been retained as an advantageous alternative to the conventional turning for parts of average dimensions, even less for parts of micrometric size.

The documents EP2314412A2, EP2374569A2, EP2489458A1 and WO2016005133A1 describe different types of equipment that make it possible to machine using a laser.

Several studies relating to texturing by femtosecond laser have been published.

In the study entitled “Development of laser turning using femtosecond laser ablation” (Yokotani, A., Kawahara, K., Kurogi, Y., Matsuo, N., Sawada, H.

and Kurosawa, K. (2002), Proceedings of SPIE, Vol. 4426, pp. 90-93), it is demonstrated that a laser technique made it possible to achieve low or deliberately high surface roughness levels on flat surfaces.

In the study entitled “Optimisation of Nd:YAG laser micro-turning process using response surface methodology” (Kibria, G., Doloi, B., Bhattacharyya, B. (2012), Int. J. Precision Technology, vol.3, No.1), an Nd:YAG laser radially strikes a rotating cylindrical ceramic part made of aluminum oxide to observe the effect of pulsed speed and energy parameters on the surface roughness. In this device, trepanation is not used and the coverage rate is driven only by the speed of rotation of the part which does not exceed 600 rpm. The part is struck radially by nanosecond pulses.

### SUMMARY OF THE INVENTION

The aim of the invention is to provide a laser turning system that makes it possible to remedy the abovementioned drawbacks and enhance the laser turning systems known from the prior art. In particular, the invention proposes a laser turning system which is competitive by comparison to the known turning systems.

A turning system according to the invention is defined by point 1 below.
1. A laser turning system for producing a timepiece component, the system comprising a rotary spindle for moving a bar of material and a galvanometric scanner capable of emitting a femtosecond laser beam scanning, notably scanning with an incidence tangential to a bar of material, a generating profile of the component to be machined in the bar of material.

Different embodiments of the system are defined by points 2 to 11 below.
2. The system as defined in the preceding point, wherein the scanner is configured to displace the focus point of the laser at a speed of more than 0.5 m/s, even more than 10 m/s, even more than 20 m/s and/or with accelerations of more than 5 m/s², even more than 500 m/52, even more than 5000 m/s², even more than 50 000 m/s².
3. The system as defined in either of the preceding points, wherein the scanner is mounted on a translation axis orthogonal to the axis of the spindle.
4. The system as defined in one of the preceding points, wherein the spindle is capable of rotating at more than 20 000 rpm, even more than 50 000 rpm, even more than 100 000 rpm.
5. The system as defined in one of the preceding points, wherein it comprises a counter spindle.
6. The system as defined in one of the preceding points, wherein the laser beam has a frequency greater than 50 kHz.
7. The system as defined in one of the preceding points, wherein it comprises an automation module comprising an element for measuring at least one dimension of the component in real time.
8. The system as defined in the preceding point, wherein it comprises a module for servocontrolling the parameters of the laser and/or the displacement of the laser beam as a function of the measurement performed by the measurement element.
9. The system as defined in one of the preceding points, wherein it comprises a rotary encoder configured so as to permanently know the angular position of the spindle, notably the absolute angular position of the spindle.
10. The system as defined in the preceding point, wherein it comprises a synchronization module configured so as to synchronize the pulses of the laser on the angular position of the spindle.
11. The system as defined in one of the preceding points, wherein it comprises a feeder.

A turning method according to the invention is defined by point 12 below.
12. A laser turning method, notably a bar turning method, for turning a timepiece component from a bar of material, the method comprising use of a system as defined in one of the preceding points.

A component according to the invention is defined by point 13 below.
13. A timepiece component obtained by implementation of the method as defined in the preceding point.

A timepiece according to the invention is defined by point 14 below.
14. A timepiece, notably a watch, in particular a wristwatch, comprising a timepiece component as defined in the preceding point.

### BRIEF DESCRIPTION OF THE DRAWINGS

The attached drawing represents, by way of example, an embodiment of a turning system according to the invention and an embodiment of a timepiece according to the invention.

FIG. 1 is a schematic view of an embodiment of a turning system according to the invention.

FIG. 2 is a schematic view of the trajectory of the laser beam according to the invention.

FIG. 3 is a schematic view of an embodiment of a timepiece according to the invention.

### DETAILED DESCRIPTION OF PARTICULAR EMBODIMENTS

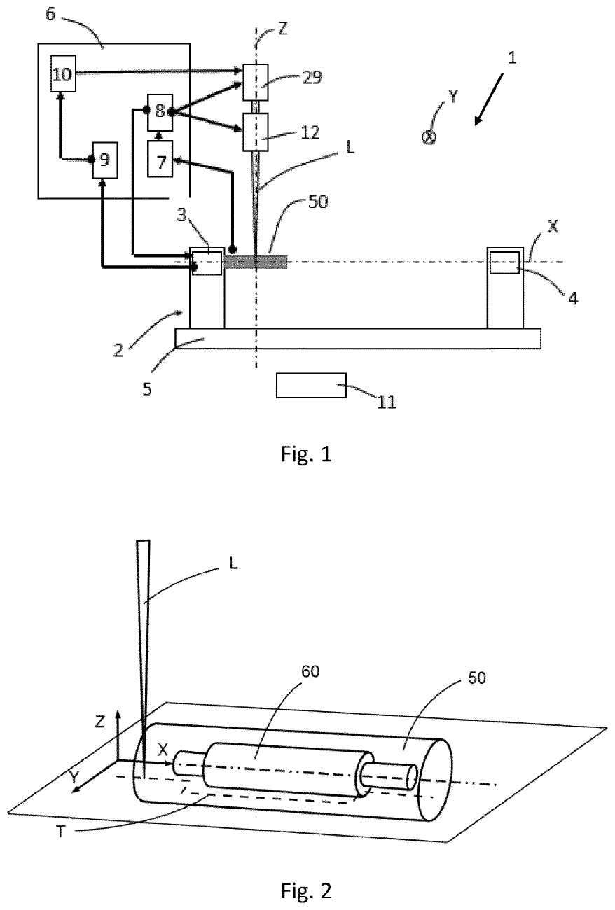

An embodiment of a turning system 1 for the production of components is described hereinbelow with reference to FIG. 1.

The system comprises:
a rotary spindle 3 for moving a bar 50 of material, and
a galvanometric scanner 12 capable of directing a femtosecond laser beam along a trajectory scanning the generating profile of the part to be machined in the bar of material. Preferably, the scanning is performed tangentially to the bar 50 of material or according to incidence tangential to the bar 50 of material.

More generally, the system comprises a module 2 for moving the bar of material, in particular for rotating the bar of material on a first axis X. This module for moving the bar of material comprises the rotary spindle 3 on the first axis X. Preferably, the spindle 3 can rotate at more than 20 000 rpm, even more than 50 000 rpm, even more than 100 000 rpm. For example, the spindle 3 is an electric spindle. Preferably, the spindle 3 is equipped with a gripping clamp, notably of pneumatic type.

The moving module 2 preferably further comprises a rotary counter spindle 4. This counter spindle 4 makes it possible to make corrections on the parts when they are detached from the spindle 3. The counter spindle 4 allows rotation on the first axis X. Preferably, the counter spindle 4 can rotate at more than 20 000 rpm, even more than 50 000 rpm, even more than 100 000 rpm. For example, the counter spindle 4 is an electric spindle. Preferably, the counter spindle 4 is equipped with a gripping clamp, notably of pneumatic type. Furthermore, the counter spindle 4 is movable in translation on the first axis X relative to the spindle 3. For example, such a counter spindle makes it possible to perform a parting machining of the component to detach it from the bar. With the traditional parting methods, the parted face of the component systematically exhibits a burr when it is detached from the bar.

The moving module 2 also comprises an element 5 allowing displacement of the spindle 3 and of the counter spindle 4 in a plane X-Y containing the first axis X and a second axis Y at right angles to the first axis X.

The system comprises an element 29 for generating a laser beam. The laser beam used to perform the machining is a laser beam composed of light pulses that have a pulse duration between 100 fs and 10 ps. It can have a frequency greater than 50 kHz, that is to say that the pulses or shots are emitted at a frequency greater than 50 kHz.

The scanner 12 is disposed between the output of the element 29 for generating the laser beam and the part to be machined, on the path of the laser beam.

The galvanometric scanner 12 is an electromechanical device incorporating from 1 to 3 axes of rotation and possibly translation axes, on which are mounted optical elements of mirror or lens type. The voltage-controlled actuators control the movement of these axes and make it possible to produce a displacement of the laser beam on two or three axes extremely rapidly and accurately. The galvanometric scanner 12 comprises a focusing device that makes it possible to concentrate the laser on a focal point. Sophisticated management of the synchronization between the movement of the optical elements and the triggering of the laser shots makes it possible to produce a generator of the machined part of revolution.

A galvanometric scanner is different from a polygonal mirror scanner which allows scanning in a single direction.

Preferably, the scanner 12 is arranged and/or configured to displace the focus point of the laser at a speed of more than 0.5 m/s, even more than 10 m/s, even more than 20 m/s. The scanner 12 is arranged and/or configured to displace the focus point of the laser with accelerations of more than 5 m/s², even more than 500 m/s², even more than 5000 m/s², even more than 50 000 m/s².

Advantageously, the scanner 12 is mounted to be movable in translation along a third axis Z orthogonal to the first and second axes X and Y. In other words, the scanner is mounted on a translation axis orthogonal to the first axis X. Thus, the galvanometric scanner makes it possible to position the focus point of the laser beam at the desired points, notably on a tangent situated on the horizontal medium plane of the bar of material being machined.

The system advantageously comprises an automation module 6 making it possible to control the machining method or the method for operating the system.

The automation module 6 comprises an element 7 for measuring in real time at least one dimension, notably a diameter of the component. The addition of this is decisive for the production of components comprising diameters of a few tens of micrometers, within tolerances of the order of a micrometer.

In fact, the diameter of a focused femtosecond laser beam is typically of the order of twenty micrometers and the depth of field is of the same order.

In laser beam machining methods with radial incidence, the laser shot impacts the layer of material located under the directly ablated layer. That is due to the incompressible depth of field of the laser beam. This physical limitation makes it impossible to produce parts of revolution with a diametral accuracy less than the order of magnitude of the size of the beam, namely twenty micrometers.

This limitation is overcome with the use of a tangentially incident laser beam. The ablation is performed by using only the edge of the Gaussian profile of the laser beam. In this particular case, the successive laser shots do not lead to additional ablation. Consequently, the precision of the diameter dimension is defined by the positioning accuracy of the laser beam and not by its size. The accuracy of the positioning of the laser beam is itself defined by the positioning accuracy of the scanner 12 and of the element 5 for displacing the spindle 3 on the axis Y and is of the order of a micrometer.

A servocontrolling of the diameter dimension by the measurement element 7, for which the measurement accuracy is of the order of a micrometer, combined with a tangential beam ablation method, makes it possible to produce turning parts with a precision on the generator of the profile of this same order, namely a micrometer.

The automation module 6 further advantageously comprises a module 8 for servocontrolling the parameters of the laser and/or the displacement of the laser beam as a function of the measurement performed by the measurement element 7.

The automation module 6 drives many actuators of the system, including the spindle 3 and/or the counter spindle 4 and/or the laser beam generation element 29. This control can be performed in particular as a function of measurements of dimensions of the machined part. For example, the servocontrol module 8 can servocontrol the speed of rotation of the spindle 3 or of the counter spindle 4 to the dimension of the part to be machined, notably to the diameter of the part to be machined. It is thus possible to vary the speeds of the spindle and counter spindle as a function of the theoretical value of the diameter to be machined, for example in order to have the same rate of latitude coverage of the impacts of the laser (function of the speed of rotation of the spindle, of the diameter machined and of the frequency of the laser). More generally, it is possible to vary the speeds of the spindle and counter spindle to obtain a variable or constant coverage rate as a function of the diameter and/or of the part of the component, for example in order to obtain a given surface texture, for example a different surface texture on different parts of the component.

The measurement element 7 can be an optical micrometer.

In addition, the automation module 6 including the measurement element 7 makes it possible to track production in order to rectify any drifts in the machining method. Through the acquisition of the data by the measurement element 7, it is possible to enhance the repeatability of the machining of the components. Through the acquisition of the data by the measurement element 7, it is possible to achieve the final dimensions of the component with very high accuracy which would not be achievable without this servocontrol, notably because of the drifts in the machining and/or the very high rotation speed of the spindle.

The automation module 6 advantageously comprises a rotary encoder 9 configured so as to permanently know the angular position of the spindle, notably the absolute angular position of the spindle.

Furthermore, the automation module 6 advantageously comprises a synchronization module 10 configured so as to synchronize the pulses of the laser on the angular position of the spindle.

Thus, it is possible to synchronize this angular position and the scanning of the scanner. It thus becomes possible to envisage producing parts comprising surfaces that are not of revolution on the first axis, such as surfaces of screw pitches, of toothings, of radial drillings, flats, grooves, surfaces of noncircular section, etc.

The system advantageously comprises a feeder 11. The feeder incorporated in the system makes it possible to automate the insertion of the bar of material into the spindle simply, without performing rotation of the counter spindle. The bar of material is then inserted into the space between the spindle and the counter spindle, then pushed by the counter spindle into the clamp of the spindle.

A mode of execution of a laser turning method, notably laser bar turning, is described hereinbelow.

The method makes it possible to obtain a timepiece component from a bar of material. The method comprises use of a laser turning system described previously.

The displacements of the laser beam L are controlled by the activation of the galvanometric scanner 12. This allows very rapid displacements of the laser beam. Consequently, the coverage rate of the impacts of the laser beam on the part to be machined is reduced and the machining quality is higher. The coverage rate is defined as the ratio between (i) the area of the surface of intersection of two successive impacts of the laser beam on the part and (ii) the area of the surface of an impact of the laser beam on the part.

The laser beam is preferably focused on the horizontal medium plane X-Y of the part, corresponding to the horizontal plane passing through the first axis X of rotation of the spindle. The beam is also oriented with a tangential or substantially tangential incidence relative to the rotating bar, that is to say oriented on the third axis Z or substantially on the third axis Z and displaced on a trajectory T tracking the desired final outline for the component, as illustrated in FIG. 2.

In this way, the material of the relevant radius of the part to be machined is entirely ablated, without additional ablation if the laser shots are continued. This would not be the case if the incidence of the laser were not tangential, in particular if the incidence of the laser beam were radial. In fact, in such a hypothesis, additional shots would result in additional ablations.

Furthermore, with a tangential incidence of the laser beam, the ablated material is ejected in a direction away from the beam and does not return into the beam and disrupt it as in the case of a radial incidence.

This configuration allows a perfect control of the machining passes. In addition, the edge of the Gaussian profile of the beam is in contact with the surface of the part to be machined. The energy applied to the surface of the part is lower than the ablation threshold, and the surface of the part thus undergoes the equivalent of a finishing pass, with a smoothing of the residual material.

Advantageously, a profile generating line of the part to be machined is created by the system 6. This line constitutes a profile along which the focus point of the laser beam is displaced along the trajectory T in the plane X-Y by the action of the galvanometric scanner 12 during the machining of the part. Furthermore, to perform the machining of the part, the part is rotated about the first axis X and the generating line is brought progressively closer to the first axis X by displacing it in the plane X-Y, in particular on the second axis Y, notably by using the element 5 of the moving module 2. The different paths of the generating line by the laser beam each constitute a machining pass.

The implementation of the method described previously makes it possible to obtain an embodiment of a component, notably a timepiece component 60, notably a timepiece staff. Preferably, the component has a diameter less than 3 mm and/or a length less than 15 mm.

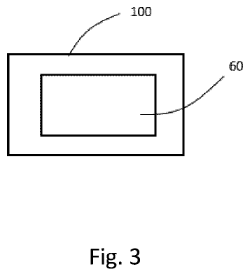

An embodiment of a timepiece 100, notably a watch, in particular a wristwatch, is represented in FIG. 3. The timepiece comprises a timepiece component 60 described previously.

The laser machining technologies make it possible to overcome the wear of the tools mentioned above, but also offer the following advantages:
the range of the materials that can be machined is greatly broadened, because there is no longer a need to take account of the behavior of the chips (notably in relation to the bar-turning steels traditionally containing sulfur as chip breaker).
The cutting force is negligible and the bar does not vibrate. In fact, the frequency of the laser shot can be servocontrolled in such a way that, as the machining progresses, the changing eigenmodes of the machined part are never excited.
No lubricant is necessary, the machining by femtosecond laser being athermal.
A hardening of the surface and/or a texturing of the surface are possible, simultaneously with the machining.

Throughout this document, the terms “bar”, “part” and “component” are used to designate the component at different stages of its production. The term “bar” preferably denotes the bar of material 50 before the start of its laser machining and at the start of its laser machining. The term “part” preferably denotes the bar or the component during the laser machining.

The term “component” preferably designates the component 60 at the end of its laser machining and after its laser machining.

1. A laser turning system for producing a timepiece component, the system comprising.
a rotary spindle for moving a bar of material, and
a galvanometric scanner capable of emitting a femtosecond laser beam scanning; a generating profile of the component to be machined in the bar of material.

2. The system as claimed in claim 1, wherein the scanner is configured to displace the focus point of the laser at a speed of more than 0.5 m/s and/or with accelerations of more than 5 m/s².

3. The system as claimed in claim 1, wherein the scanner is mounted on a translation axis orthogonal to a main axis of the spindle.

4. The system as claimed in claim 1, wherein the spindle is capable of rotating at more than 20,000 rpm.

5. The system as claimed in claim 1, wherein the system comprises a counter spindle.

6. The system as claimed in claim 1, wherein the laser beam has a frequency greater than 50 kHz.

7. The system as claimed in claim 1, wherein the system comprises an automation module comprising a measurement element for measuring at least one dimension of the component in real time.

8. The system as claimed in claim 7, wherein the system comprises a module for servocontrolling parameters of the laser and/or a displacement of the laser beam as a function of a measurement performed by the measurement element.

9. The system as claimed in claim 1, wherein the system comprises a rotary encoder configured to permanently know an angular position of the spindle.

10. The system as claimed in claim 9, wherein the system comprises a synchronization module configured to synchronize pulses of the laser on the angular position of the spindle.

11. The system as claimed in claim 1, wherein the system comprises a feeder.

12. A laser turning method for turning a timepiece component from a bar of material using the system of claim 1, the method comprising:
using the rotary spindle to move the bar of material, and
using the galvanometric scanner to emit a femtosecond laser beam scanning a generating profile of the component to be machined in the bar of material.

13. A timepiece component obtained by implementation of the method as claimed in claim 12.

14. A timepiece comprising a timepiece component as claimed in claim 13.

15. The system as claimed in claim 1, wherein the galvanometric scanner is capable of emitting a femtosecond laser beam scanning with an incidence tangential to a bar of material.

16. The system as claimed in claim 2, wherein the scanner is configured to displace the focus point of the laser at a speed of more than 10 m/s.

17. The system as claimed in claim 2, wherein the scanner is configured to displace the focus point of the laser at a speed of more than 20 m/s and/or with accelerations of more than 500 m/s².

18. The system as claimed in claim 4, wherein the spindle is capable of rotating at more than 50,000 rpm.

19. The system as claimed in claim 4, wherein the spindle is capable of rotating at more than 100,000 rpm.

20. The system as claimed in claim 9, wherein the rotary encoder is configured to permanently know the absolute angular position of the spindle.
